(19) United States
(12) Patent Application Publication
(10) Pub. No.: US 2025/0372625 A1
(43) Pub. Date: Dec. 4, 2025

(54) NEGATIVE ELECTRODE FOR NONAQUEOUS ELECTROLYTE SECONDARY BATTERIES, AND NONAQUEOUS ELECTROLYTE SECONDARY BATTERY

(71) Applicant: Panasonic Energy Co., Ltd., Moriguchi-shi, Osaka (JP)

(72) Inventors: Sachiyo Kaneko, Tokushima (JP); Takamitsu Tashita, Tokushima (JP); Akihiro Katogi, Osaka (JP)

(73) Assignee: Panasonic Energy Co., Ltd., Moriguchi-shi, Osaka (JP)

(21) Appl. No.: 18/876,880

(22) PCT Filed: Jun. 22, 2023
(86) PCT No.: PCT/JP2023/023234

§ 371 Date: Dec. 19, 2024

(30) Foreign Application Priority Data
Jun. 29, 2022 (JP) 2022-105053

(51) Int. Cl. H01M 4/36; H01M 4/02; H01M 4/133; H01M 4/134; H01M 4/38; H01M 4/587

(52) U.S. Cl. CPC H01M 4/366; H01M 4/133; H01M 4/134; H01M 4/364; H01M 4/386; H01M 4/587; H01M 2004/021; H01M 2004/027

(57) ABSTRACT

A negative electrode for nonaqueous electrolyte secondary batteries comprises a negative electrode mixture layer and is characterized in that: the negative electrode mixture layer comprises a first negative electrode mixture layer, and a second negative electrode mixture layer; the first negative electrode mixture layer contains graphite particles A; the second negative electrode mixture layer contains the graphite particles A and graphite particles B which have a lower internal void fraction than the graphite particles A; the second negative electrode mixture layer comprises a first region and a second region; the content ratio of the graphite particles B in the first region is higher than the content ratio of the graphite particles in the second region; and the ratio (T1/T2) of the thickness (T1) of the first negative electrode mixture layer to the thickness (T2) of the second negative electrode mixture layer is within the range of 0.66 to 4.00.

### TECHNICAL FIELD

The present disclosure relates to a non-aqueous electrolyte secondary battery negative electrode and a non-aqueous electrolyte secondary battery.

### BACKGROUND

A non-aqueous electrolyte secondary battery is widely used as a secondary battery having a high energy density. Patent Literature 1 discloses a technology in which a negative electrode mixture layer has a two-layer structure and a porosity of the negative electrode mixture layer on a positive electrode side is larger than that of the negative electrode mixture layer on a negative electrode current collector side from the viewpoint of increasing the capacity.

### CITATION LIST

### Patent Literature

Patent Literature 1: JP 2003-77463 A

### SUMMARY

However, in Patent Literature 1, charge-discharge cycle characteristics are not addressed, and there is room for improvement.

Therefore, an object of the present disclosure is to provide a non-aqueous electrolyte secondary battery negative electrode and a non-aqueous electrolyte secondary battery capable of suppressing deterioration of charge-discharge cycle characteristics.

A non-aqueous electrolyte secondary battery negative electrode according to an aspect of the present disclosure includes: a negative electrode current collector; and a negative electrode mixture layer formed on a surface of the negative electrode current collector, in which the negative electrode mixture layer includes a first negative electrode mixture layer disposed on the negative electrode current collector and a second negative electrode mixture layer disposed on the first negative electrode mixture layer, the first negative electrode mixture layer contains graphite particles A, the second negative electrode mixture layer contains the graphite particles A and graphite particles B having an internal porosity lower than that of the graphite particles A, the second negative electrode mixture layer has a first region and a second region disposed on the first negative electrode mixture layer, a content ratio of the graphite particles B in the first region is higher than a content ratio of the graphite particles in the second region, and a ratio (T1/T2) of a thickness (T1) of the first negative electrode mixture layer to a thickness (T2) of the second negative electrode mixture layer is in a range of greater than or equal to 0.66 and less than or equal to 4.00.

Further, a non-aqueous electrolyte secondary battery according to one aspect of the present disclosure includes the non-aqueous electrolyte secondary battery negative electrode, a positive electrode, and a non-aqueous electrolyte.

According to one aspect of the present disclosure, deterioration of the charge-discharge cycle characteristics can be suppressed.

### BRIEF DESCRIPTION OF DRAWINGS

FIG. 1 is a cross-sectional view of a non-aqueous electrolyte secondary battery as an example of an embodiment.

FIG. 2 is a cross-sectional view of a negative electrode as an example of the embodiment.

FIG. 3 is a plan view of the negative electrode as an example of the embodiment.

FIG. 4 is a cross-sectional view illustrating a particle cross section of a graphite particle.

FIG. 5 is a plan view illustrating another example of a second negative electrode mixture layer.

FIG. 6 is a plan view illustrating another example of the second negative electrode mixture layer.

### DESCRIPTION OF EMBODIMENTS

Hereinafter, an example of an embodiment will be described in detail with reference to the drawing. Note that a non-aqueous electrolyte secondary battery of the present disclosure is not limited to the embodiment described below. The drawings referred to in the description of the embodiment are schematically illustrated.

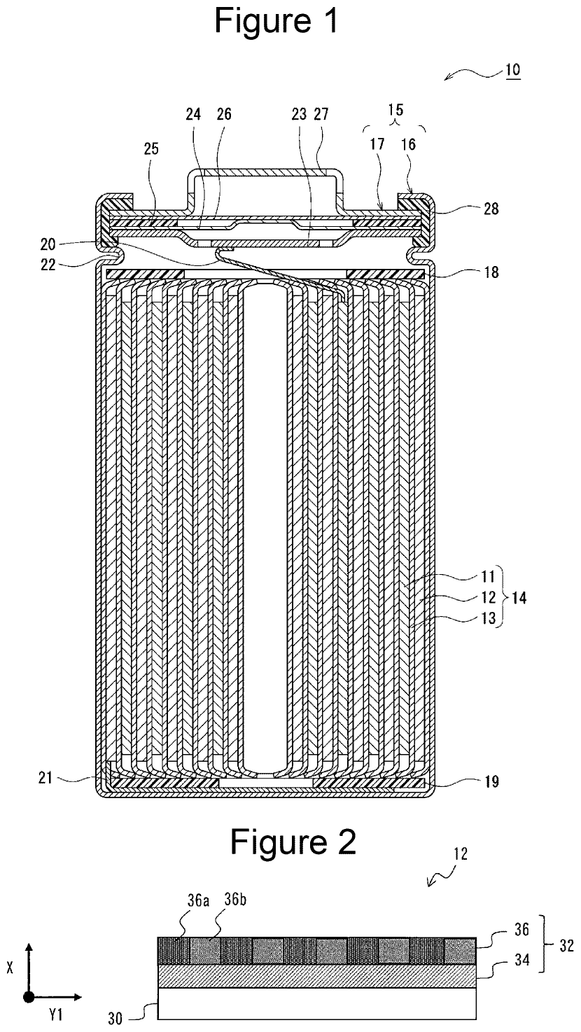

FIG. 1 is a cross-sectional view of the non-aqueous electrolyte secondary battery as an example of the embodiment. A non-aqueous electrolyte secondary battery 10 illustrated in FIG. 1 includes a winding-type electrode assembly 14 formed by winding a positive electrode 11 and a negative electrode 12 with a separator 13 interposed therebetween, a non-aqueous electrolyte, insulating plates 18 and 19 respectively disposed above and below the electrode assembly 14, and a battery case 15 housing the above-mentioned members. The battery case 15 includes a bottomed cylindrical case body 16 and a sealing assembly 17 that closes an opening of the case body 16. Instead of the winding-type electrode assembly 14, an electrode assembly having another form, such as a stacked electrode assembly in which positive electrodes and negative electrodes are alternately stacked with separators interposed therebetween, may be applied. Examples of the battery case 15 include metallic exterior cans having a cylindrical shape, a square shape, a coin shape, a button shape, or the like, and pouch exterior bodies formed by lamination with a resin sheet and a metal sheet.

The case body 16 is, for example, a bottomed cylindrical metallic exterior can. A gasket 28 is provided between the case body 16 and the sealing assembly 17 to ensure the sealing performance inside the battery. The case body 16 has a projecting portion 22 that supports the sealing assembly 17, the projecting portion 22 being, for example, a part of a side portion of the case body 16 that protrudes inward. The projecting portion 22 is preferably formed in an annular shape along a circumferential direction of the case body 16, and supports the sealing assembly 17 on an upper surface thereof.

The sealing assembly 17 has a structure in which a filter 23, a lower vent member 24, an insulating member 25, an upper vent member 26, and a cap 27 are sequentially stacked from an electrode assembly 14 side. Each member included in the sealing assembly 17 has, for example, a disk shape or a ring shape, and the members excluding the insulating member 25 are electrically connected to each other. The lower vent member 24 and the upper vent member 26 are connected to each other at the respective central portions, and the insulating member 25 is interposed between the respective peripheral portions. When an internal pressure of the non-aqueous electrolyte secondary battery 10 increases due to heat generation due to an internal short circuit or the like, for example, the lower vent member 24 is deformed so as to push up the upper vent member 26 toward the cap 27 and breaks, and a current path between the lower vent member 24 and the upper vent member 26 is cut off. When the internal pressure further increases, the upper vent member 26 breaks, and gas is discharged from an opening of the cap 27.

In the non-aqueous electrolyte secondary battery 10 illustrated in FIG. 1, a positive electrode lead 20 attached to the positive electrode 11 extends through a through-hole of the insulating plate 18 toward the sealing assembly 17, and a negative electrode lead 21 attached to the negative electrode 12 extends through the outside of the insulating plate 19 toward a bottom side of the case body 16. The positive electrode lead 20 is connected to a lower surface of the filter 23, which is a bottom plate of the sealing assembly 17, by welding or the like, and the cap 27, which is electrically connected to the filter 23 and is a top plate of the sealing assembly 17, serves as a positive electrode terminal. The negative electrode lead 21 is connected to a bottom inner surface of the case body 16 by welding or the like, and the case body 16 serves as a negative electrode terminal.

Hereinafter, each component of the non-aqueous electrolyte secondary battery 10 will be described in detail.

### Negative Electrode

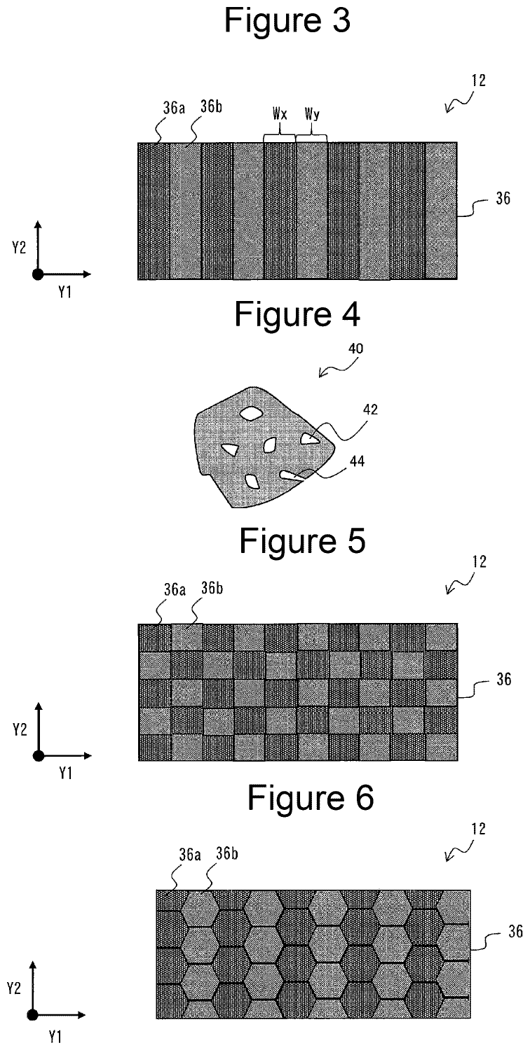

FIG. 2 is a cross-sectional view of the negative electrode as an example of the embodiment, and FIG. 3 is a plan view of the negative electrode as an example of the embodiment. FIGS. 2 and 3 illustrate the negative electrode 12 in a state before being wound as the electrode assembly 14 in FIG. 1. In the following description, in a planar direction of the negative electrode 12 orthogonal to a thickness direction (an arrow X in FIG. 2) of the negative electrode 12, a longitudinal direction of the negative electrode 12 is referred to as a first direction (an arrow Y1 in FIGS. 2 and 3), and a width direction of the negative electrode 12 orthogonal to the first direction is referred to as a second direction (an arrow Y2 in FIG. 3).

As illustrated in FIG. 2, the negative electrode 12 includes a negative electrode current collector 30 and a negative electrode mixture layer 32 formed on the surface of the negative electrode current collector 30. As the negative electrode current collector 30, for example, a foil of a metal such as copper which is stable in a potential range of the negative electrode 12, a film in which the metal is disposed on a surface layer, or the like is used. A thickness of the negative electrode current collector 30 is, for example, greater than or equal to 5 μm and less than or equal to 30 μm.

The negative electrode mixture layer 32 includes a first negative electrode mixture layer 34 disposed on the negative electrode current collector 30 and a second negative electrode mixture layer 36 disposed on the first negative electrode mixture layer 34. The second negative electrode mixture layer 36 has a first region 36a and a second region 36b disposed on the first negative electrode mixture layer 34. As illustrated in FIG. 3, the first region 36a and the second region 36b are arranged in a stripe shape in plan view. That is, the first region 36a and the second region 36b are alternately arranged in the first direction (the arrow Y1 that indicates the longitudinal direction of the negative electrode). The first region 36a and the second region 36b extend in the second direction (the arrow Y2 that indicates the width direction of the negative electrode) and reach both ends of the negative electrode 12 in the width direction.

The first negative electrode mixture layer 34 contains graphite particles A as a negative electrode active material. In addition, the second negative electrode mixture layer 36 contains the graphite particles A as the negative electrode active material and graphite particles B having an internal porosity lower than that of the graphite particles A. A content ratio of the graphite particles B in the first region 36a of the second negative electrode mixture layer 36 is higher than a content ratio of the graphite particles B in the second region 36b. A ratio (T1/T2) of a thickness (T1) of the first negative electrode mixture layer to a thickness (T2) of the second negative electrode mixture layer is in a range of greater than or equal to 0.66 and less than or equal to 4.00. Here, the content ratio of the graphite particles B in the first region 36a is a proportion of the graphite particles B relative to the total mass of the graphite particles contained in the first region 36a, and the content ratio of the graphite particles B in the second region 36b is a proportion of the graphite particles B relative to the total mass of the graphite particles contained in the second region 36b. Further, the internal porosity of the graphite particle refers to a two-dimensional value determined from a ratio of an area of an internal pore of the graphite particle to a cross-sectional area of the graphite particle. As illustrated in FIG. 4, the internal pore of the graphite particle is a closed pore 42 that is not connected to the surface of the particle from the inside of the particle in a cross-sectional view of a graphite particle 40. A pore 44 connected to the surface of the particle from the inside of the particle illustrated in FIG. 4 is referred to as an external pore, and is not included as the internal pore. A method of measuring the internal porosity of the graphite particle is described below.

As described above, by making the content ratio of the graphite particles B in the first region 36a of the second negative electrode mixture layer 36 higher than the content ratio of the graphite particles B in the second region 36b, it is presumed that the non-aqueous electrolyte permeates into the second region 36b in which the number of graphite particles B having a low internal porosity is small through the first region 36a in which the number of the graphite particles B having a low internal porosity is large, and thus permeability of the non-aqueous electrolyte into the negative electrode mixture layer is improved as compared with the negative electrode mixture layer not containing the graphite particles B. By containing the graphite particles B having a low internal porosity, a gap between the graphite particles is easily secured even by rolling at the time of producing the negative electrode. Therefore, in the first region 36a containing a large amount of graphite particles B having a low internal porosity, there are more gaps between the graphite particles than in the second region 36b, and thus, the non-aqueous electrolyte easily permeates from the first region 36a. In addition, in the second region 36b in which the number of graphite particles B having a low internal porosity is small, the graphite particles are crushed by rolling at the time of producing the negative electrode, and the number of gaps between the graphite particles is reduced, and thus, the thickness tends to be slightly smaller than that of the first region 36a. As a result, irregularities are generated on the surface of the second negative electrode mixture layer 36, and thus, the non-aqueous electrolyte easily enters through a gap formed by the irregularities. Therefore, it is presumed that this also improves the permeability of the non-aqueous electrolyte into the negative electrode mixture layer 32. By setting the thickness ratio (T1/T2) between the first negative electrode mixture layer 34 formed on the negative electrode current collector 30 and the second negative electrode mixture layer 36 formed on the first negative electrode mixture layer 34 within a range of greater than or equal to 0.66 and less than or equal to 4.00, an effect of the permeability of the non-aqueous electrolyte by the second negative electrode mixture layer 36 described above is sufficiently exhibited, and deterioration of charge-discharge cycle characteristics of the battery is suppressed.

The internal porosities of the graphite particles A and B are determined by the following procedure.

### Method of Measuring Internal Porosity

(1) A cross section of a negative electrode active material layer is exposed. Examples of a method of exposing the cross section include a method of exposing the cross section of the negative electrode active material layer by cutting a part of the negative electrode and machining the cut part with an ion milling apparatus (for example, IM4000PLUS manufactured by Hitachi High-Tech Corporation).

(2) A backscattered electron image of the exposed cross section of the negative electrode active material layer is captured using a scanning electron microscope. A magnification when the backscattered electron image is captured is 3,000 times to 5,000 times.

(3) A cross-sectional image acquired by the above-described process is read into a computer, binarization processing is applied using an image analyzing software (for example, ImageJ manufactured by National Institutes of Health), and a binarized image is acquired in which a particle cross section in the cross-sectional image is converted into black color and pores existing in the particle cross section are converted into white color.

(4) The graphite particles A and B having a particle diameter of greater than or equal to 5 μm and less than or equal to 50 μm are selected from the binarized image, and the area of the graphite particle cross section and the area of the internal pores existing in the graphite particle cross section are calculated. Here, the area of the graphite particle cross section refers to an area of a region surrounded by an outer periphery of the graphite particle, that is, an area of the entire cross-sectional portion of the graphite particle. In addition, among the pores existing in the graphite particle cross section, for a pore having a width of less than or equal to 3 μm, it may be difficult to determine whether the pore is the internal pore or the external pore in the image analysis, and thus, the pore having the width of less than or equal to 3 μm may be determined as the internal pore. The internal porosity of the graphite particle is calculated (the area of the internal pore of the graphite particle cross section×100/the area of the graphite particle cross section) based on the calculated area of the graphite particle cross section and the calculated area of the internal pore of the graphite particle cross section. The internal porosity of each of the graphite particles A and B is an average value of ten graphite particles A or B.

The internal porosity of the graphite particle A is, for example, preferably higher than or equal to 8% and lower than or equal to 20%, more preferably higher than or equal to 10% and lower than or equal to 18%, and particularly preferably higher than or equal to 12% and lower than or equal to 16%. The graphite particle A having such a high internal porosity can be produced, for example, as follows. Cokes (precursors) which are a primary raw material are ground to a predetermined size, and, in a state in which the cokes are aggregated with a binder and then the aggregate is pressurized and shaped into a block, the aggregate is baked at a temperature of higher than or equal to 2,600° C. for graphitization. The block-shape formation after the graphitization is ground and filtered, to obtain the graphite particles of a desired size. Here, by increasing the amount of a volatile composition added to the block-shape formation, the internal porosity of the graphite particle can be increased (for example, in a range of higher than or equal to 8% and lower than or equal to 20%). When a part of the binder added to the cokes (precursors) vaporizes during the baking, the binder may be used as the volatile composition. A pitch may be exemplified as such a binder.

The internal porosity of the graphite particle B is, for example, preferably less than or equal to 5%, more preferably higher than or equal to 1% and less than or equal to 5%, and particularly preferably higher than or equal to 3% and lower than or equal to 5%. The graphite particle having such a low internal porosity can be produced, for example, as follows. Cokes (precursors) which are a primary raw material are ground to a predetermined size, and, in a state in which the cokes are aggregated with a binder, the aggregate is baked at a temperature of higher than or equal to 2,600° C. for graphitization, and the resulting graphites are then filtered to obtain the graphite particles of a desired size. Here, the internal porosity of the graphite particle may be adjusted by a particle diameter of the precursor after the grinding, a particle diameter of the precursor in the aggregated state, or the like. For example, by increasing the particle diameter of the precursor after grinding or the particle diameter of the precursor in the aggregated state, the internal porosity of the graphite particle can be decreased (for example, less than or equal to 5%).

No particular limitation is imposed on the graphite particles A and B used in the present embodiment, such as natural graphite and artificial graphite, but from the viewpoint of ease of adjustment of the internal porosity, the artificial graphite is desirably employed. A plane spacing (d₀₀₂) of a (002) plane determined by an X-ray wide angle diffraction for the graphite particles A and B used in the present embodiment is desirably, for example, greater than or equal to 0.3354 nm, is more desirably greater than or equal to 0.3357 nm, is desirably less than 0.340 nm, and is more desirably less than or equal to 0.338 nm. In addition, a crystallite size (Lc(002)) determined by the X-ray diffraction for the graphite particles A and B used in the present embodiment is desirably, for example, greater than or equal to 5 nm, is more desirably greater than or equal to 10 nm, is desirably less than or equal to 300 mm, and is more desirably less than or equal to 200 nm. When the plane spacing (d₀₀₂) and the crystallite size (Lc(002) satisfy the above ranges, the battery capacity of the non-aqueous electrolyte secondary battery tends to be larger than that when the above ranges are not satisfied. At least a part of the surface of the graphite particle A may be coated with amorphous carbon.

In the present embodiment, the content ratio of the graphite particles B in the first region 36a may be higher than the content ratio of the graphite particles in the second region 36b. Therefore, the first region 36a may contain only the graphite particles B among the graphite particles A and B, or may contain the graphite particles A and B. In addition, the second region 36b may contain only the graphite particles A among the graphite particles A and B, or may contain the graphite particles A and B. From the viewpoint of suppressing the deterioration of the charge-discharge cycle characteristics, the first region 36a preferably contains both the graphite particles A and B. In this case, a range of a mass ratio of the graphite particles A and the graphite particles B in the first region 36a is preferably, for example, a range of greater than or equal to 2:8 and less than or equal to 4:6.

The content ratio of the graphite particles B in the first region 36a is, for example, preferably higher than or equal to 40 mass % and lower than or equal to 100 mass %, and more preferably higher than or equal to 60 mass % and lower than or equal to 100 mass % or less, relative to the total mass of the graphite particles contained in the first region 36a, from the viewpoint of suppressing the deterioration of the charge-discharge cycle characteristics. In addition, the content ratio of the graphite particles B in the second region 36b is, for example, preferably higher than or equal to 0% by mass and lower than 40% by mass, and more preferably higher than or equal to 0% by mass and lower than 20% by mass, relative to the total mass of the graphite particles contained in the second region 36b, from the viewpoint of suppressing the deterioration of the charge-discharge cycle characteristics.

The first negative electrode mixture layer 34 may contain only the graphite particles A or may contain the graphite particles A and B. However, the graphite particles contained in the first negative electrode mixture layer 34 are preferably only the graphite particles A from the viewpoint of improving adhesion between the negative electrode mixture layer 32 and the negative electrode current collector 30 and further suppressing the deterioration of the charge-discharge cycle characteristics. In a case where the first negative electrode mixture layer 34 contains both the graphite particles A and B, the mass ratio of the graphite particles A and the graphite particles B in the first negative electrode mixture layer 34 is preferably in a range of greater than or equal to 7:3 and less than or equal to 9:1, for example, from the viewpoint of adhesion between the negative electrode mixture layer 32 and the negative electrode current collector 30.

The ratio (T1/T2) of the first negative electrode mixture layer 34 (T1) to the thickness (T2) of the second negative electrode mixture layer 36 may be in a range of greater than or equal to 0.66 and less than or equal to 4.00, but is preferably in a range of greater than or equal to 1.00 and less than or equal to 2.50 from the viewpoint of further suppressing the deterioration of the charge-discharge cycle characteristics.

A ratio (Wx/Wy) of a width (Wx illustrated in FIG. 3) of the first region 36a in the first direction to a width (Wy illustrated in FIG. 3) of the second region 36b in the first direction is preferably, for example, higher than or equal to 0.03 and lower than or equal to 3.13. In a case where Wx/Wy satisfies the above range, for example, the permeability of the non-aqueous electrolyte into the negative electrode mixture layer 32 is improved as compared with a case where Wx/Wy does not satisfy the above range, and the deterioration of the charge-discharge cycle characteristics may be further suppressed.

The arrangement of the first region 36a and the second region 36b in plan view is not limited to the stripe shape as illustrated in FIG. 3. FIGS. 5 and 6 are plan views illustrating another example of the second negative electrode mixture layer. The first region 36a and the second region 36b may be arranged in a lattice pattern such as a checkered pattern as illustrated in FIG. 5, or may be arranged in a honeycomb shape as illustrated in FIG. 6, for example, in plan view. Although not illustrated in the drawings, the first region 36a and the second region 36b may be arranged in a spiral shape in plan view, for example.

As the negative electrode active material contained in the negative electrode mixture layer 32, other materials capable of reversibly absorbing and releasing lithium ions may be contained in addition to the graphite particles A and B used in the present embodiment, and for example, a Si-based material may be contained. Examples of the Si-based material include Si, an alloy containing Si, a silicon oxide such as SiO_{X} (X is greater than or equal to 0.8 and less than or equal to 1.6), and a Si-containing material in which Si fine particles are dispersed in a lithium silicate phase represented by Li_{2y}SiO_{(2+y)} (0<y<2). When the Si-based material is contained as the negative electrode active material, the capacity of the battery can be increased. A content of the Si-based material is, for example, preferably greater than or equal to 1% by mass and less than or equal to 10% by mass, and more preferably greater than or equal to 3% by mass and less than or equal to 7% by mass, with respect to the total mass of the negative electrode active material contained in the negative electrode mixture layer 32, from the viewpoint of increasing the battery capacity, suppressing the deterioration of the charge-discharge cycle characteristics, and the like.

Other examples of the other materials capable of reversibly absorbing and releasing lithium ions include Sn, an alloy containing Sn, a Sn-based material such as tin oxide, and a Ti-based material such as lithium titanate. The negative electrode active material may contain the other material, and the content of the other material is desirably, for example, less than or equal to 10 mass % with respect to the total mass of the negative electrode active material contained in the negative electrode mixture layer 32.

The negative electrode mixture layer 32 may contain a conductive agent. Examples of the conductive agent include carbon materials such as carbon black (CB), acetylene black (AB), Ketjenblack, graphite, and carbon nanotube (CNT). The conductive agents may be used alone or in combination of two or more thereof.

The negative electrode mixture layer 32 may further contain a binder. Examples of the binder include a fluorine-based resin, a polyimide-based resin, an acrylic resin, a polyolefin-based resin, polyacrylonitrile (PAN), styrene-butadiene rubber (SBR), nitrile-butadiene rubber (NBR), carboxymethyl cellulose (CMC) or a salt thereof, polyacrylic acid (PAA) or a salt thereof (PAA-Na, PAA-K, or the like, or partially neutralized salt may be used), and polyvinyl alcohol (PVA). These may be used singly or in combination of two or more kinds thereof.

An example of a method of manufacturing the negative electrode 12 according to the present embodiment will be described. First, the graphite particles A, the binder, and a solvent such as water are mixed to prepare a slurry for the first negative electrode mixture layer. Separately, the graphite particles A and B, the binder, and the solvent such as water are mixed to prepare a slurry for the first region, and the graphite particles A and B, the binder, and the solvent such as water are mixed to prepare a slurry for the second region. Here, a content of the graphite particles B in the slurry for the first region is larger than a content of the graphite particles B in the slurry for the second region. Then, the slurry for the first negative electrode mixture layer is applied onto both surfaces of the negative electrode current collector and dried. Then, the slurry for the first region and the slurry for the second region are alternately applied in a surface direction onto a coating film formed using a first negative electrode mixture slurry, and rolled by a rolling roller. As a result, it is possible to produce the negative electrode 12 in which the first negative electrode mixture layer 34 is formed on the negative electrode current collector 30 and the second negative electrode mixture layer 36 having the first region 36a and the second region 36b is formed on the first negative electrode mixture layer 34. In the above method, the slurry for the first negative electrode mixture layer is applied and dried, and then the slurry for the first region and the slurry for the second region are applied. However, the slurry for the first region and the slurry for the second region may be applied after the slurry for the first negative electrode mixture layer is applied and before the slurry for the first negative electrode mixture layer is dried. The slurry for the first region and the slurry for the second region may be applied onto the first negative electrode mixture layer 34 after the slurry for the first negative electrode mixture layer is applied, dried, and rolled.

### Positive Electrode

The positive electrode 11 includes a positive electrode current collector such as a metal foil and a positive electrode mixture layer formed on the positive electrode current collector. The positive electrode current collector may be, for example, a foil of a metal, such as aluminum, which is stable in a potential range of the positive electrode 11 or a film in which the metal is disposed on the surface layer thereof. The positive electrode mixture layer may contain, for example, a positive electrode active material, a binder, and a conductive agent. The positive electrode 11 can be produced, for example, by applying a positive electrode mixture slurry containing the positive electrode active material, the binder, the conductive agent, and the like onto the positive electrode current collector, drying the slurry to form the positive electrode mixture layer, and then rolling the positive electrode mixture layer.

Examples of the positive electrode active material include lithium transition metal oxides containing transition metal elements such as Co, Mn, and Ni. Examples of the lithium transition metal oxides include LiₓCoO₂, LiₓNiO₂, LiₓMnO₂, LiₓCo_{y}Ni_{1-y}O₂, LiₓCo_{y}M_{1-y}O_{z}, LiₓNi_{1-y}M_{y}O_{z}, LiₓMn₂O₄, LiₓMn_{2-y}M_{y}O₄, LiMPO₄, and LiMPO₄F (M; at least one of Na, Mg, Sc, Y, Mn, Fe, Co, Ni, Cu, Zn, Al, Cr, Pb, Sb, or B, 0<x≤ 1.2, 0<y≤0.9, 2.0≤z≤2.3). These may be used singly, or a plurality of kinds of them may be mixed and used. The positive electrode active material preferably contains a lithium nickel composite oxide such as LiₓNiO₂, LiₓCo_{y}Ni_{1-y}O₂, and LiₓNi_{1-y}M_{y}O_{z} (M; at least one of Na, Mg, Sc, Y, Mn, Fe, Co, Ni, Cu, Zn, Al, Cr, Pb, Sb, and B, 0<x≤1.2, 0<y≤0.9, 2.0≤z≤2.3) from the viewpoint of being able to increase the capacity of the non-aqueous electrolyte secondary battery.

Examples of the conductive agent include carbon particles such as carbon black (CB), acetylene black (AB), Ketjenblack, carbon nanotube (CNT), graphene, and graphite. These may be used singly or in combination of two or more kinds thereof.

Examples of the binder include a fluorine-based resin such as polytetrafluoroethylene (PTFE) or polyvinylidene fluoride (PVdF), a polyimide-based resin, an acrylic resin, a polyolefin-based resin, and polyacrylonitrile (PAN). These may be used singly or in combination of two or more kinds thereof.

### Separator

As the separator 13, for example, a porous sheet having ion permeability and insulating property is used. Specific examples of the porous sheet include fine porous thin films, woven fabrics, and nonwoven fabrics. As a material of the separator, olefin-based resins such as polyethylene and polypropylene, cellulose, and the like are suitable. The separator 13 may be a stacked body including a cellulose fiber layer and a thermoplastic resin fiber layer such as an olefin-based resin. Further, the separator 13 may be a multi-layer separator including a polyethylene layer and a polypropylene layer, and a separator obtained by applying a material such as an aramid-based resin or ceramic to the surface of the separator 13 may be used.

### Non-Aqueous Electrolyte

The non-aqueous electrolyte is a liquid electrolyte (electrolytic solution) containing a non-aqueous solvent and an electrolyte salt dissolved in the non-aqueous solvent. Examples of a solvent that can be used as the non-aqueous solvent include esters, ethers, nitriles such as acetonitrile, amides such as dimethylformamide, and mixed solvents of greater than or equal to two of them. The non-aqueous solvent may contain a halogen-substituted product in which at least some of hydrogen in any of the solvents described above is substituted with a halogen atom such as fluorine.

Examples of the esters include cyclic carbonates such as ethylene carbonate (EC), propylene carbonate (PC), and butylene carbonate, chain carbonates such as dimethyl carbonate (DMC), ethyl methyl carbonate (EMC), diethyl carbonate (DEC), methyl propyl carbonate, ethyl propyl carbonate, and methyl isopropyl carbonate, cyclic carboxylic acid esters such as γ-butyrolactone and γ-valerolactone, and chain carboxylic acid esters such as methyl acetate, ethyl acetate, propyl acetate, methyl propionate (MP), and ethyl propionate.

Examples of the ethers include cyclic ethers such as 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineole, and crown ether, and chain ethers such as 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether.

As the halogen-substituted product, an ester is preferably used such as a fluorinated cyclic carbonic acid ester such as fluoroethylene carbonate (FEC), a fluorinated chain carbonic acid ester, or a fluorinated chain carboxylic acid ester such as methyl fluoropropionate (FMP).

The electrolyte salt is preferably a lithium salt. Examples of the lithium salt include LiBF₄, LiClO₄, LiPF₆, LiAsF₆, LiSbF₆, LiAlCl₄, LiSCN, LiCF₃SO₃, LiCF₃CO₂, Li(P(C₂O₄)F₄), LiPF₆₋ₓ(CₙF₂ₙ₊₁)ₓ (1<x<6, n is 1 or 2), LiB₁₀Cl₁₀, LiCl, LiBr, LiI, chloroborane lithium, lower aliphatic lithium carboxylates, and borates such as Li₂B₄O₇ and Li(B(C₂O₄)F₂), and imide salts such as LiN(SO₂CF₃)₂ and LiN(CₗF₂ₗ₊₁SO₂)(CₘF₂ₘ₊₁SO₂) {l and m are integers of greater than or equal to 1}. These lithium salts may be used singly, or a plurality of kinds of them may be mixed and used. Among these lithium salts, LiPF₆ is preferably used from the viewpoints of ion conductivity, electrochemical stability, and the like. The concentration of the lithium salt is preferably greater than or equal to 0.8 mol and less than or equal to 1.8 mol per L of the solvent.

### EXAMPLES

Hereinafter, the present disclosure will be further described with reference to Examples, but the present disclosure is not limited to Examples.

### Example 1

### Production of Positive Electrode

As a positive electrode active material, a lithium transition metal oxide represented by LiNi_{0.88}Co_{0.09}Al_{0.03} was used. 100 parts by mass of the positive electrode active material, 0.8 parts by mass of carbon black as a conductive agent, and 0.7 parts by mass of polyvinylidene fluoride powder as a binder were mixed, and an appropriate amount of N-methyl-2-pyrrolidone (NMP) was further added to prepare a positive electrode mixture slurry. The slurry was applied onto both surfaces of a positive electrode current collector formed of an aluminum foil (having a thickness of 15 μm), a coating film was dried, and then the coating film was rolled by a rolling roller, thereby producing a positive electrode in which a positive electrode mixture layer was formed on both surfaces of the positive electrode current collector.

### Production of Graphite Particles A

Cokes were ground until an average particle diameter (D50) reached 15 μm, and pitch as the binder was added to the ground cokes to aggregate the cokes. An isotropic pressure was applied to the aggregate to prepare a block-shape formation having a density of greater than or equal to 1.6 g/cm³ and less than or equal to 1.9 g/cm³. The block-shape formation was fired at a temperature of 2800° C. to be graphitized, and then the graphitized block-shape formation was ground and sieved to obtain the graphite particles A having a volume average particle diameter (D50) of 23 μm.

### Production of Graphite Particles B

Cokes were ground until the average particle diameter (D50) reached 12 μm, pitch as the binder was added to the ground coke, and the coke was aggregated until the average particle diameter (D50) reached 17 μm. The aggregate was fired at a temperature of 2800° C. to be graphitized. Next, the graphitized block-shape formation was ground and sieved to obtain the graphite particles B having a volume average particle diameter (D50) of 23 μm.

### Production of Negative Electrode

The graphite particles A and SiO were mixed at a mass ratio of 95:5 to obtain a first negative electrode active material. 100 parts by mass of the first negative electrode active material, 1 part by mass of a sodium salt of carboxymethyl cellulose (CMC-Na), and 1 part by mass of styrene-butadiene copolymer rubber (SBR) were mixed, and the mixture was kneaded in water to prepare a slurry for a first negative electrode mixture layer.

Mixed graphite obtained by mixing 20 parts by mass of the graphite particles A and 80 parts by mass of the graphite particles B was mixed with SiO at a mass ratio of 95:5 to obtain a second negative electrode active material. 100 parts by mass of the second negative electrode active material, 1 part by mass of CMC-Na, and 1 part by mass of SBR were mixed, and the mixture was kneaded in water to prepare a slurry for a first region. Further, the graphite particles A and SiO were mixed at a mass ratio of 95:5 to obtain a third negative electrode active material. 100 parts by mass of the third negative electrode active material, 1 part by mass of a sodium salt of carboxymethyl cellulose (CMC-Na), and 1 part by mass of styrene-butadiene copolymer rubber (SBR) were mixed, and the mixture was kneaded in water to prepare a slurry for a second region.

The slurry for the first negative electrode mixture layer was applied to both surfaces of a negative electrode current collector made of a copper foil and dried to form the first negative electrode mixture layer. Further, the slurry for the first region and the slurry for the second region were alternately applied onto the first negative electrode mixture layer (that is, the slurry for the first region and the slurry for the second region were applied in a stripe shape), and dried to form a second negative electrode mixture layer having the first region and the second region of which the ratio of the width (Wx) to the width (Wy) in the second direction was 1:1. The first negative electrode mixture layer and the second negative electrode mixture layer were rolled using a rolling roller to produce a negative electrode. The ratio of the thickness (T2) of the first negative electrode mixture layer (T1) and the second negative electrode mixture layer of the produced negative electrode was 5:5.

For the obtained negative electrode, the internal porosities of the graphite particle A and the graphite particle B in the negative electrode mixture layer were measured. As a result, the internal porosity of the graphite particle A was 15%, and the internal porosity of the graphite particle B was 3%. A method of measuring the internal porosity is as described above.

### Preparation of Non-Aqueous Electrolyte

2 parts by mass of vinylene carbonate (VC) was added to a non-aqueous solvent obtained by mixing ethylene carbonate (EC), dimethyl carbonate (DMC), and ethyl methyl carbonate (EMC) at a volume ratio of 2:6:2, and LiPF₆ as an electrolyte was dissolved at a concentration of 1.3 mol/L. In this way, the non-aqueous electrolyte was prepared.

### Manufacture of Test Cell

A positive electrode lead made of aluminum was attached to the positive electrode current collector, and a negative electrode lead made of nickel was attached to the negative electrode current collector to prepare a stacked electrode assembly in which the positive electrode and the negative electrode were stacked with a separator made of polyolefin interposed therebetween. The electrode assembly was housed in an exterior body formed of an aluminum laminate sheet, the non-aqueous electrolyte was injected, and then an opening of the exterior body was sealed to obtain a test cell.

### Example 2

A test cell was prepared in the same manner as in Example 1 except that the thickness ratio between the first negative electrode mixture layer (T1) and the second negative electrode mixture layer (T2) of the negative electrode was 7:3.

### Example 3

A test cell was prepared in the same manner as in Example 1 except that the thickness ratio between the first negative electrode mixture layer (T1) and the second negative electrode mixture layer (T2) of the negative electrode was 8:2.

### Example 4

A test cell was produced in the same manner as in Example 1 except that the second negative electrode active material obtained by mixing mixed graphite obtained by mixing 40 parts by mass of the graphite particles A and 60 parts by mass of the graphite particles B, and SiO at a mass ratio of 95:5 was used in the preparation of the slurry for the first region, and the third negative electrode active material was used by mixing mixed graphite obtained by mixing 80 parts by mass of the graphite particles A and 20 parts by mass of the graphite particles B, and SiO at a mass ratio of 95:5 in the preparation of the slurry for the second region.

### Example 5

A test cell was prepared in the same manner as in Example 1 except that the thickness ratio between the first negative electrode mixture layer (T1) and the second negative electrode mixture layer (T2) of the negative electrode was 4:6.

### Comparative Example 1

A test cell was prepared in the same manner as in Example 1 except that the thickness ratio between the first negative electrode mixture layer (T1) and the second negative electrode mixture layer (T2) of the negative electrode was 9:1.

### Comparative Example 2

A test cell was prepared in the same manner as in Example 1 except that the thickness ratio between the first negative electrode mixture layer (T1) and the second negative electrode mixture layer (T2) of the negative electrode was 2:8.

### Comparative Example 3

A test cell was produced in the same manner as in Example 1 except that the second negative electrode active material obtained by mixing mixed graphite obtained by mixing 60 parts by mass of the graphite particles A and 40 parts by mass of the graphite particles B, and SiO at a mass ratio of 95:5 was used in the preparation of the slurry for the first region, and the third negative electrode active material was used by mixing mixed graphite obtained by mixing 60 parts by mass of the graphite particles A and 40 parts by mass of the graphite particles B, and SiO at a mass ratio of 95:5 in the preparation of the slurry for the second region.

### Comparative Example 4

A test cell was prepared in the same manner as in Example 1 except that the first negative electrode mixture layer was not formed and the second negative electrode mixture layer was directly formed on the negative electrode current collector.

### Evaluation of Capacity Retention Rate

At an environmental temperature of 25° C., the test cells of Examples and Comparative Examples were charged at a constant current of 1 C to 4.2 V, and then charged at a constant voltage of 4.2 V to 1/50 C. Thereafter, constant current discharge was performed at 0.5° C. to 2.5 V. The charge/discharge was defined as one cycle, and 200 cycles were performed. A capacity retention rate during a charge and discharge cycle of the test cell of each of Examples and each of Comparative Examples was obtained using the following equation.

Capacity retention rate (%)=(Discharge capacity at 200-th cycle/Discharge capacity at First cycle)×100

Table 1 summarizes the results of the capacity retention rates of the test cells of Examples and Comparative Examples.

TABLE 1

| | Mass ratio of graphite particles | | | | Capacity |
|---|---|---|---|---|---|
| | Graphite particles A:Graphite particles B | | | Thickness | retention |
| | | Second layer | | ratio | rate |
| | First layer | First region | Second region | T1:T2 | (%) |
| Example 1 | 100:0 | 20:80 | 100:0 | 5:5 | 84 |
| Example 2 | 100:0 | 20:80 | 100:0 | 7:3 | 85 |
| Example 3 | 100:0 | 20:80 | 100:0 | 8:2 | 84 |
| Example 4 | 100:0 | 40:60 | 80:20 | 5:5 | 79 |
| Example 5 | 100:0 | 20:80 | 100:0 | 4:6 | 78 |
| Comparative Example 1 | 100:0 | 20:80 | 100:0 | 9:1 | 70 |
| Comparative Example 2 | 100:0 | 20:80 | 100:0 | 2:8 | 73 |
| Comparative Example 3 | 100:0 | 60:40 | 60:40 | 5:5 | 60 |
| Comparative Example 4 | — | 20:80 | 100:0 | 0:10 | 74 |

First layer: first negative electrode mixture layer, and second layer: second negative electrode mixture layer

The capacity retention rates of all of the test cells of Examples 1 to 5 were improved as compared with the test cells of Comparative Examples 1 to 4. Therefore, the deterioration of the charge-discharge cycle characteristics can be suppressed by making the content ratio of the graphite particles B having a low internal porosity contained in the second negative electrode mixture layer in the first region higher than in the second region and by making T1/T2 of the thickness (T2) of the second negative electrode mixture layer and the thickness (T1) of the first negative electrode mixture layer between the second negative electrode mixture layer and the negative electrode current collector be in a range of greater than or equal to 0.66 and less than or equal to 4.00 as in the test cells of Examples.

### Supplementary Note

(1)

A non-aqueous electrolyte secondary battery negative electrode including:
a negative electrode current collector; and a negative electrode mixture layer formed on a surface of the negative electrode current collector, in which
the negative electrode mixture layer includes a first negative electrode mixture layer disposed on the negative electrode current collector and a second negative electrode mixture layer disposed on the first negative electrode mixture layer,
the first negative electrode mixture layer contains graphite particles A, the second negative electrode mixture layer contains the graphite particles A and graphite particles B having an internal porosity lower than that of the graphite particles A,
the second negative electrode mixture layer has a first region and a second region disposed on the first negative electrode mixture layer, a content ratio of the graphite particles B in the first region is higher than a content ratio of the graphite particles in the second region, and
a ratio (T1/T2) of a thickness (T1) of the first negative electrode mixture layer to a thickness (T2) of the second negative electrode mixture layer is in a range of greater than or equal to 0.66 and less than or equal to 4.00.
   (2)

The non-aqueous electrolyte secondary battery negative electrode according to (1), in which the graphite particle A has an internal porosity of greater than or equal to 8% and less than or equal to 20%, and the graphite particle B has an internal porosity of less than or equal to 5%.

(3)

The non-aqueous electrolyte secondary battery negative electrode according to (1) or (2), in which a content ratio of the graphite particles B in the first region is greater than or equal to 40 mass % and less than or equal to 100 mass % with respect to a total mass of the graphite particles contained in the first region, and a content ratio of the graphite particles B in the second region is greater than or equal to 0 mass % and less than 40 mass % with respect to a total mass of the graphite particles contained in the second region.

(4)

The non-aqueous electrolyte secondary battery negative electrode according to any one of (1) to (3), in which the first region and the second region are arranged in a stripe shape, a lattice shape, or a honeycomb shape in plan view.

(5)

The non-aqueous electrolyte secondary battery negative electrode according to any one of (1) to (4), in which a ratio (S1/S2) of a thickness (S1) of the first region to a thickness (S2) of the second region is higher than or equal to 1.0 and lower than or equal to 1.2.

(6)

The non-aqueous electrolyte secondary battery negative electrode according to any one of (1) to (5), in which the negative electrode mixture layer contains a Si-based material.

(7)

A non-aqueous electrolyte secondary battery including: the non-aqueous electrolyte secondary battery negative electrode according to any one of (1) to (6); a positive electrode; and a non-aqueous electrolyte.

### REFERENCE SIGNS LIST

10 Non-aqueous electrolyte secondary battery
11 Positive electrode
12 Negative electrode
13 Separator
14 Electrode assembly
15 Battery case
16 Case body
17 Sealing assembly
18, 19 Insulating plate
20 Positive electrode lead
21 Negative electrode lead
22 Projecting portion
23 Filter
24 Lower vent member
25 Insulating member
26 Upper vent member
27 Cap
28 Gasket
30 Negative electrode current collector
32 Negative electrode mixture layer
34 First negative electrode mixture layer
36 Second negative electrode mixture layer
36a First region
36b Second region
40 Graphite particle
42, 44 Pore

1. A non-aqueous electrolyte secondary battery negative electrode comprising:
a negative electrode current collector; and a negative electrode mixture layer formed on a surface of the negative electrode current collector, wherein
the negative electrode mixture layer includes a first negative electrode mixture layer disposed on the negative electrode current collector and a second negative electrode mixture layer disposed on the first negative electrode mixture layer,
the first negative electrode mixture layer contains graphite particles A, the second negative electrode mixture layer contains the graphite particles A and graphite particles B having an internal porosity lower than that of the graphite particles A,
the second negative electrode mixture layer has a first region and a second region disposed on the first negative electrode mixture layer, a content ratio of the graphite particles B in the first region is higher than a content ratio of the graphite particles in the second region, and
a ratio (T1/T2) of a thickness (T1) of the first negative electrode mixture layer to a thickness (T2) of the second negative electrode mixture layer is in a range of greater than or equal to 0.66 and less than or equal to 4.00.

2. The non-aqueous electrolyte secondary battery negative electrode according to claim 1, wherein the graphite particle A has an internal porosity of greater than or equal to 8% and less than or equal to 20%, and the graphite particle B has an internal porosity of less than or equal to 5%.

3. The non-aqueous electrolyte secondary battery negative electrode according to claim 1, wherein a content ratio of the graphite particles B in the first region is greater than or equal to 40 mass % and less than or equal to 100 mass % with respect to a total mass of the graphite particles contained in the first region, and a content ratio of the graphite particles B in the second region is greater than or equal to 0 mass % and less than 40 mass % with respect to a total mass of the graphite particles contained in the second region.

4. The non-aqueous electrolyte secondary battery negative electrode according to claim 1, wherein the first region and the second region are arranged in a stripe shape, a lattice shape, or a honeycomb shape in plan view.

5. The non-aqueous electrolyte secondary battery negative electrode according to claim 1, wherein the negative electrode mixture layer contains a Si-based material.

6. A non-aqueous electrolyte secondary battery comprising: the non-aqueous electrolyte secondary battery negative electrode according to claim 1; a positive electrode; and a non-aqueous electrolyte.
